(19) United States
(12) Patent Application Publication
(10) Pub. No.: US 2007/0233336 A1
(43) Pub. Date: Oct. 4, 2007

(54) Method and apparatus for navigating unmanned vehicle using sensor fusion

(75) Inventors: Boldyrev Serguei, Gyeonggi-do (KR); Jun-seok Shim, Gyeonggi-do (KR); Kyung-shik Roh, Gyeonggi-do (KR); Woo-sup Han, Gyeonggi-do (KR); Woong Kwon, Gyeonggi-do (KR)

Correspondence Address: BUCHANAN, INGERSOLL & ROONEY PC, POST OFFICE BOX 1404, ALEXANDRIA, VA, 22313-1404, US

(73) Assignee: Samsung Electronics Co., Ltd, Gyeonggi-do (KR)

(21) Appl. No.: 10/951,908

(22) Filed: Sep. 29, 2004

(30) Foreign Application Priority Data
Sep. 30, 2003 (KR) 2003-68073

(51) Int. Cl. G01C 21/00

(52) U.S. Cl. 701/23

(57) ABSTRACT

A method and apparatus for navigating an unmanned vehicle using sensor fusion are provided. This method includes: measuring a plurality of parameters using at least two sensors that sense a result of a position estimation of the unmanned vehicle; selectively combining the measured parameters; detecting changes of the parameters within expected ranges; and estimating a position of the unmanned vehicle represented by an unknown state of sensor data and a desired inference, using estimation and error distribution. The apparatus is scalable, so it can be easily expanded or compressed under any environmental conditions. The apparatus is also survivable, so if a sensor source is lost or malfunctions, it is not a disaster for the whole system, but it just decreases exponential-related error estimation. The apparatus is also modular, so the apparatus can easily determine what kind of sensor is responsible for what kind of sensing.

### BACKGROUND OF THE INVENTION

This application claims the benefit of Korean Patent Application No. 2003-68073, filed on Sep. 30, 2003, in the Korean Intellectual Property Office, the disclosure of which is incorporated herein in its entirety by reference.

1. Field of the Invention

The present invention relates to a method and apparatus for navigating an unmanned vehicle, and more particularly, to a method and system for performing sensor fusion for unmanned vehicle navigation.

2. Description of the Related Art

Currently, sensors data fusion techniques do not provide an exact solution for a defined problem. When defining a solution using data fusion, researchers usually need to build a custom approach, although a well-known kernel (e.g., a Kalman filter scheme) can be used. Realization of a system that uses such an approach to combine data, which sometimes extremely increases the complexity of calculation, can be very difficult and expensive. Providing a series of estimators has been proposed, but only a few of them can be implemented in a series in realistic scenarios and have constraints in that an estimator function must be performed in real time. Dominating approaches in sensors data fusion use an ordinary Kalman Filtering (KF) technique, an Extended Kalman Filtering (EKF) technique, Covariance Intersection (CI), Hidden Markov Models (HMM), a Partially Observable Markov Decision Process (POMDP), or a Bayesian Networks solution. Each of these techniques has its own restrictions and bounds of use. A major restriction is that a model dependent upon distribution must be used. In the case of EKF, a cross-correlation product must be calculated. In the case of POMDP, a low link between previous and present states (conditions) of some process must be analyzed. Accordingly, there are several well-known approaches to building a sensing structure. The most well-known sensing structures are a decentralized fusion structure, a distributed fusion structure, a federated fusion structure, and a hierarchical fusion structure. Each of these fusion structures has several advantages and disadvantages.

The decentralized and distributed fusion structures are scalable, survivable, and modular. However, these structures have a disadvantage in that error estimation depends upon a fusion channel.

The federated and hierarchical fusion structures have advantages in that recursive error estimation is possible for each fusion cascade and that modularization is possible. These fusion structures are, however, non-scalable and have a low survivability.

Sensors data fusion in the mobile robotics field is performed using two or three major approaches. Up to now, the EKF has unquestionably been the dominating state estimation technique. The EKF is based on first-order Taylor approximations of state transitions and observation equations related to an estimated state trajectory. Application of EKF is therefore contingent upon the assumption that the required derivatives exist and can be obtained with a reasonable effort. The Taylor linearization provides an insufficiently accurate representation in many cases, and significant biases, or even convergent problems, are commonly encountered due to the overly crude approximations.

Several estimation techniques, for example, re-iteration, high order filtering, and statistical linearization, which are more sophisticated than the EKF, are available. The more advanced techniques generally improve estimation accuracy, but this improvement occurs at the expense of a further complication in implementation and increased computation.

### SUMMARY OF THE INVENTION

The present invention provides a method of and an apparatus for navigating an unmanned vehicle using a sensor fusion system that is scalable, survivable, and modular.

According to an aspect of the present invention, there is provided a method of navigating an unmanned vehicle, including: measuring a plurality of parameters using at least two sensors that sense a result of a position estimation of the unmanned vehicle; selectively combining the measured parameters; detecting changes of the parameters within expected ranges; and estimating a position of the unmanned vehicle represented by sensor data and a desired data deviation, using estimation and error distribution. In the measuring of the parameters, a source signal is first received. Then, the source signal is transformed into a frequency-domain signal using fast Fourier transformation, and a spectrum density function is calculated. Then, a polynomial is fitted to a spectrum- and signal-dependent representation, and a corresponding correlation function and corresponding coefficients are calculated.

According to another aspect of the present invention, there is provided an apparatus navigating an unmanned vehicle using sensor fusion, the apparatus including: a sensor channel unit including sensors and control signal sequences, extracting raw data from the sensors, and transmitting the raw data to a pre-processing layer; a cross-channel model calculation/feedback support unit calculating cross-products including cross- and auto-correlation channels to perform a fusion algorithm, supporting error feedback for channel parameters, and obtaining error estimation for signal processing representation; an estimation decomposition unit generating a linear combination of orthogonal weight functions, generating a set of weight functions for estimation signal representation corresponding to signal key features, and obtaining rules for error compensation in consideration of an error estimation equation; an estimation superimposing unit that superimpose the weight function generated by estimation decomposition unit on a set of decomposition weight coefficients and corresponding set of estimations of distributed random values on measured signal values; and a final product calculation unit extracting necessary information related to a final product calculation, extracting key features related to localization according to a position and a current state of the unmanned vehicle, correlating a final product with an environment state, and obtaining unscaled and uncalibrated information about the position of the unmanned vehicle. The sensor channel unit analyzes a signal in a spectrum domain by processing signal data using a fast Fourier transform. The sensor channel unit tracks a state of a spectrum function, predicts and analyzes a state of a sensor channel, fits a polynomial to the spectrum function using an auto-regression method and a least mean-squared error method, obtains key parameters of the sensor channel using abstract models of the sensor channel, and tunes the sensor channel during some time according to the environmental conditions. The cross-channel model calculation/feedback support unit calculates a correlation function either by raw signal transformation via integral convolution or by the use of spectrum functions and power spectrum functions. When calculating a correlation function by using the spectrum functions and power spectrum functions, the cross-channel model calculation/feedback support unit determines a cross-noise weight in signal channels using the spectrum functions and the power spectrum functions, analyzes a signal spectrum function, extracts information about the environment at early stages, and obtains cross-related products, error minimization feedback support, and key frequencies of sensor channels.

The present invention also provides a computer-readable recording medium in which a computer program for executing the above-described method is recorded.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an apparatus navigating an unmanned vehicle using sensors fusion according to an embodiment of the present invention;

FIG. 2 is a detailed block diagram of the apparatus of FIG. 1;

FIG. 3 is a block diagram of a constitution of the apparatus of FIG. 1;

FIG. 4 illustrates position information (X, Y, and theta) of a vehicle; and

FIG. 5 illustrates a raw signal containing information about a vehicle.

### DETAILED DESCRIPTION OF THE INVENTION

The present invention will now be described in detail.

1. Introduction

The present invention provides a new sensor data fusion technique that uses an object-like layered structure approach. The sensors data fusion technique is based on approximation of non-linear transformations obtained by a multi-dimensional extension of a Karhunen-Loewe decomposition method. The principle of this approach is different from conventional filtering techniques. Due to the use of the Karhunen-Loewe decomposition method, no derivatives are needed for interpolation. Even predefined equations are not needed because of the employment of a principle of auto-regression polynomial fitting based on spectrum functions calculated from sensor signals. Of course, there must be an upper bound on the order of a polynomial. Although the implementation of the multi-sensor data fusion technique is as complicated as filters based on Taylor approximations, computations are greatly reduced. Additionally, under certain assumptions about the distribution of estimation errors, the multi-sensor data fusion technique provides more precise error-calculation, so that errors are compensated for. Because of minimization based on deep feedback to entry points in the multisensor data fusion technique, it is possible to obtain error estimation with higher precision than in other filtering techniques (including Taylor approximation).

2. General Approach

A decomposition method for signal processing and advantages of the decomposition method will now be described. In one popular approach for signal processing, a signal is represented as a set of periodic well-defined functions with coefficients. A big advantage of this approach is that the signal could be easily explained with qualitative and quantitative parameters. It is also well-known that with the help of this approach, a signal could be studied in a frequency domain (spectrum representation).

In the present invention, signal representation in the frequency domain shows key frequencies and a general picture of sensors channels. Analysing the most popular structures in sensor fusion techniques, it is clear that no methods or structures use signal pre-analysis. Although such a technique is applied in a wide range of industrial applications, it is not often applied to mobile robotics applications. The reliability of current approach [signal representation approach] is well known because of source quality analyzing. With source quality analysing, it is possible to monitor and diagnose channel state prediction.

With respect to Simultaneous Localization and Mapping (SLAM) or self-navigation techniques, one of the major problems in a perception apparatus of a robot system is sensor signal processing and, consequently, sensor data fusion. However, if a signal is dropped or disturbed by noise, it is clear that values input to the sensor data fusion will be disturbed and therefore a disturbed determination result will be output from the sensor data fusion and wrong position and/or orientation information will be produced at a final stage of data processing. Because of this, it is necessary to use a light and robust technique that is easily implemented for the monitoring and diagnosing of source signals. Thus, a combined or hybrid method for the sensor data fusion is proposed.

In the method according to the present invention, there are several layers for proper in-process (real-time) source signal pre-processing and data fusion. For clear understanding, it is necessary to provide an explanation of the method according to the present invention.

The following general structure for the source signal pre-processing is proposed:
(1) Reception of a source signal;
(2) Transformation of the source signal into a frequency-domain signal using Fast Fourier Transformation;
(3) Calculation of a spectrum density function;
(4) Fitting of a polynomial into the spectrum- and signal-dependent representation (in-process signal analysing-channel stability and quality);
(5) Calculation of corresponding correlation (covariation) functions and corresponding coefficients;
(6) Performing a decomposition method, which is the kernel of the method of the present invention; and
(7) Calculation of prediction and error estimation models.

Each of the above steps will now be described. First, a representative polynomial is fitted to a spectrum function.

Then, the quality of a signal can be analysed using the distribution of roots of the representative polynomial in a T-R domain. Such an approach is very useful when the main requirement is the obtaining of a transformation function that could describe a condition of and a state of the process (or a representation signal of the process). It is possible to obtain key frequencies (main, characteristical frequencies of the process) and analyze which part of a hardware device affects signal processing.

Then, the correlation (covariation) functions can be calculated in two ways: from the source, raw signal, which provides a native picture of a source; and from the spectrum function, which provides a correlation picture from a frequency domain.

An overview of some keys in a mathematical background of the present invention will now be made.

3. Definition and Description of the Present Invention

A kernel of the sensors data fusion method according to an embodiment of the present invention will now be defined. To represent the method simply, a one-dimensional case is considered. This method can be easily extended to an N-dimensional case. The quantity of independent channels is supposed by the meaning of a dimension.

The base of invention is algorithm for representation of an observable process such as a stochastic (random) process within some well-defined constraints. The main principle of the proposed method is the decomposition of a non-periodic stochastic process into a series of orthogonal functions with uncorrelated coefficients. Simultaneously, during the decomposition, an error minimization method is implemented. This error minimization provides a robust technique of reducing noise and errors of cross-channels and in-channels. Consequently, a resultant product of the method can be easily used to extract necessary information. An additional property for data analysis is used to overview the above mentioned spectrum functions. The method will now be described step by step.

3.1. Definition of Estimation

A definition of the source signal is considered to be a time-related function. In the present invention, it is necessary to identify a resultant function that describes the environmental states clearly and robustly. So, a statistical estimation value Ŷ of a signal system (SS) can be obtained through the determination of parameters of an operator F(X(t)). The statistical estimation value Ŷ is given by: Ŷ=F(X(t: 0≦t≦T)) of some indicator Yε [symbol] using a physically measured condition coordinate SS X(t)εR^{q}.

A one-dimensional case (p=q=1) will now be considered, and an aspect of building and applying linear estimation will now be described.

The statistical estimation value is given by:
\hat{Y}=(a,X)+b=∫₀^{T}a(t)X(t)dt+b, (1)
wherein a=a(t) denotes a function obtained by analyzing the source signal, X=X(t) denotes a square of a continuous mean of a stochastic process occurring when tε[0,τ], which can be represented like source signal deviation, b denotes a free parameter, [0,τ] denotes a period of SS functioning, and Tε[0,τ], denotes a determined time for measurement.

All finite-dimensional distributions of random value sets Y and X(t) for tε[0,τ] are uniform (normal) distributions, and parameters a and b for linear estimation of Equation 1 are obtained from a minimum value of error propagation, ε=Y−Ŷ, which means a minimum of Equation 2:
J=J(a,b)=E[ε²]=E[(Y−Ŷ)²]=E[(Y−(a,X)−b)²] (2)

According to Equation 2, the weight function a usually belongs to a class of functions defined for tε[0,T]. The class of functions can be selected through a priori determination or based on a prior analysis of the random value sets Y and X(t) for tε[0,τ].

When L₂[0,T] is fixed, Equation 2 becomes Equation 3:
J=E[(Y−(a,X))²]−2bE[(Y−(a,X))]+b², (3)

From Equation 3, J is minimized when b=b⁰ and bεR. Here, b⁰=b⁰(a) is given by:
b⁰=E[(Y−(a,X))]=E[Y]−∫₀^{T}a(t)E[X(t)]dt. (4)

After centering random values Y and X(t) using E (estimation),
y=Y−E[Y], x(t)=X(t)−E[X(t)] (5)
is obtained. Equation 6 will be considered:
y=(a,x)=∫₀^{T}a(t)x(t)dt (6)

By substituting Equation 4 into Equations 1 and 2 and considering Equations 5 and 6, Equations 7, 8, and 9 can be obtained:
Ŷ=E[Y]+∫₀^{T}a(t)(X(t)−E[X(t)])dt=E[Y]+∫₀^{T}a(t)x(t)dt=E[Y]+y. (7)
ε=Y−Ŷ=Y−E[Y]−y=y−y. (8)
J=E[ε²]E[(Y−Ŷ)²]=E[(y−y)²]=E[(y−(a,x))²] (9)

From Equations 7 and 8, estimation of Y and error estimation ε are given by:
E[Y]=E[Y], E[ε]=0. (10)

Equation 10 describes a property of non-biased estimation of Equation 1 when b=b⁰.

A function of Equation 9, which depends upon a only, is considered as J=J(a). At this point, a well-defined relation between an error minimization function and a determined function is obtained. As described above, it is clear that dependence between an error estimation system and a constant definition can be ignored and avoided.

3.2. Decomposition

From a classical approach to correlation and cross-correlation functions, Equations 11 and 12 can be obtained:
r(t)=E[(Y−E[Y])(X(t)−E[X(t)])]=E[yx(t)] (11)
R(t,s)=E[(X(t)−E[X(t)])(X(s)−E[X(s)])]=E[x(t)x(s)] (12)

Equation 9 can be rewritten as Equation 13:
J=J(a)=E[y²]∫₀^{T}a(t)r(t)dt+∫₀^{T}∫₀^{T}R(t,s)a(t)a(s)dtds (13)

To determine the parameter a, a highlighted class of weight functions and an effective minimization algorithm of J=J(a) need to be described in consideration of the highlighted class of weight functions.

Fundamentally, to solve such a task (as with all tasks in a technical cybernetics area), an orthogonal system of functions {φᵢ: 1≦i≦∞} over [0,T] normalized using private correlation functions R(t, s) is needed, and is defined by:
∫₀^{T}R(t,s)φ(s)ds=λᵢφᵢ(t), (0≦t,s≦T) (14)

Karhunen-Loewe orthogonal decomposition is given by:

$$x ( t ) = {\sum }_{i = 1}^{∞} {ξ}_{i} {φ}_{i} ( t ) , ( t ∈ [ 0 , T ] ) \qquad ( 15 )$$

wherein ζ is a real or complex number, which can be defined as:
ξ=(x,φᵢ)=∫₀^{T}x(t)φᵢ(t)dt (16)

A non-periodic random process cannot be expressed as a Fourier series with uncorrelated random coefficients, but it can be expanded to a series of orthogonal functions {φᵢ: 1≦i≦∞} with uncorrelated coefficients.

Equation 15 converges to a mean-square value uniformly over [0,T], and the orthogonal system {φᵢ: 1≦i≦∞} spans L₂[0,T]. Consequently, each weight function a□L₂[0,T] can be obtained to arbitrary precision (with L₂[0,T] space dimension) to approximate with linear combinations of a finite set of φᵢ functions.

Since the orthogonal system {φᵢ: 1≦i≦∞} is orthogonal over L₂[0,T],
(φᵢ,φⱼ)=∫₀^{T}φᵢ(t)φⱼ(t)dt=δᵢⱼ (17)
holds, wherein δᵢⱼ is the Kronecker delta.

By combining Equations 15 through 17 with Equation 12, Equation 18 can be obtained:
E[ξᵢξⱼ]=E[∫₀^{T}x(s)φᵢ(s)ds ·∫₀^{T}x(t)φⱼ(t)dt]= . . . =∫₀^{T}∫₀^{T}R(t,s)φᵢ(t)φⱼ(s)dtdt=λᵢ∫₀^{T}φᵢ(t)φⱼ(t)dt (18)

All private values (λᵢ≧0) are considered from a non-negative determination of the private correlation function R(t, s). From the aforementioned Equations and Equation 17, Equation 18 can be rewritten as:
E[ξᵢξⱼ]=\sqrt{λᵢ}\sqrt{λᵢ}δᵢⱼ (19)

Equations 17 and 18 reflect properties of orthogonal decomposition in Equation 15. Because a random process x=x(t) is centered, Equation 19 reduces to:
E[ξᵢ]=0; var ξᵢ=E[ξᵢ²]=λᵢ (20)

As described above, considering a uniform process X=X(t), it is concluded from Equations 16, 19, and 20 that the coefficients ζᵢ of Equation 15 are independent of uniformly distributed random values and that ζᵢεN(0, λᵢ). It is clear that only elements corresponding to positive λᵢ are important in the decomposition of Equation 15.

3.3. Combining and Superimposing

A final product of decomposition is given by the sum of an estimation of an output function and error estimation—a minimization function for system quality determination. Assuming that
a(t)=α₁φ₁(t)+ . . . +αₘφₘ(t); α₁, . . . , αₘε [symbol] (21)
for fixed m, and
ρᵢ=[ξᵢy] (22),

$$\begin{matrix}\hat{y} = ( a , x ) = {\int }_{0}^{T} a ( t ) x ( t ) ⅆ t = {\sum }_{i = 1}^{∞} {\sum }_{i = 1}^{∞} {α}_{i} {ξ}_{i} ( {φ}_{i} , {φ}_{j} ) = {\sum }_{i = 1}^{∞} {α}_{i} {ξ}_{i} & ( 23 ) \\ \begin{matrix}J = J ( a ) \\ = E [ {( y - \hat{y} )}^{2} ] \\ = E [ {( y - {\sum }_{i = 1}^{∞} {α}_{i} {ξ}_{i} )}^{2} ] \\ = E [ {y}^{2} ] - 2 {\sum }_{i = 1}^{∞} {α}_{i} {ρ}_{i} + {\sum }_{i = 1}^{∞} {α}_{i}^{2} {λ}_{i} ,\end{matrix} & ( 24 )\end{matrix}$$

are obtained from Equations 6 and 9 using Equations 15, 17, and 19.

From Equations 21 and 22, it is clear that, if λᵢ=0 for some i, ρᵢ=0. Therefore, Equation 24 is independent of the parameters αᵢ of the weight function a. Thus, all values λᵢ (1≦i≦m) are positive. Considering coefficients λᵢ⁰ of the weight function a, Equation 25 is obtained:
a⁰(t)=α₁⁰φ₁(t)+ . . . +αₘ⁰φₘ(t) (25)

Equation 25 provides a minimum for J=J(a) when a(t) is of the form shown in Equation 21, and αᵢ can be written in the form:

$${α}_{i}^{0} = \frac{{ρ}_{i}}{{λ}_{i}} ( 1 \leq i \leq m ) \qquad ( 26 )$$

By substituting Equation 26 into Equation 24, Equation 27 is obtained:

$$J ( {a}^{0} ) = E [ {y}^{2} ] - {\sum }_{1 \leq i \leq m} \frac{{ρ}_{i}^{2}}{{λ}_{i}} \qquad ( 27 )$$

By referring to Equation 21, Equation 28 is obtained:

$$J ( {a}^{0} ) = ( 1 - {\sum }_{1 \leq i \leq m} {cor}^{2} ( {ξ}_{i} , y ) ) E [ {y}^{2} ] \qquad ( 28 )$$

wherein cor(ξᵢ,y) denotes a coefficient of a correlation between random values ξᵢ and y.

According to Equations 23 and 26, the statistical estimation value Ŷ, which is a response of a⁰ of Equation 24 is given by:

$$\hat{Y} = E [ Y ] + \hat{y} \\ \hat{y} = {\sum }_{1 \leq i \leq m} {ξ}_{i} \frac{{ρ}_{i}^{2}}{{λ}_{i}} \qquad ( 29 )$$

The dispersion σₛ²=J(a⁰) of error propagation ε=Y−Ŷ can be obtained from Equation 27 or 28.

It could be noted that characteristics of μ_{Y}=E[Y], σ_{Y}²=var Y=E[y²] for a random value Y and correlation functions r(t) and R(t,s) in real cases are not always predefined.

Equations 30, 31, 32, and 33 are given by:

$$\begin{matrix}{\hat{μ}}_{Y} = \hat{Y} = [ \frac{1}{n} ] {\sum }_{1 \leq v \leq n} {Y}_{v} & ( 30 ) \\ {\hat{σ}}_{Y}^{2} = [ \frac{1}{n - 1} ] {\sum }_{1 \leq v \leq n} {( {Y}_{v} - \overline{Y} )}^{2} & ( 31 ) \\ \hat{r} ( t ) = [ \frac{1}{n - 1} ] {\sum }_{1 \leq v \leq n} ( {Y}_{v} - \overline{Y} ) ( {X}_{v} ( t ) - \overline{X} ( t ) ) , \\ ( \overline{X} ( t ) = [ \frac{1}{n} ] {\sum }_{1 \leq v \leq n} {X}_{v} ( t ) ) & ( 32 ) \\ \hat{R} ( t , s ) = [ \frac{1}{n - 1} ] {\sum }_{1 \leq v \leq n} ( {X}_{v} ( t ) - X ( t ) ) ( {X}_{v} ( s ) - X ( s ) ) & ( 33 )\end{matrix}$$

wherein n is number of observations, Y_{ν} and X_{ν}(t) represents Y and X(t) random values, which respond to the observation ν (1≦ν≦n).

3.4. Analyzing

The above-described equations are a part of a mathematical tool for a propagation and estimation system for estimating a current position and orientation of a mobile device, based on the SS.

These results can be easily expanded to a multi-dimensional case, which allows the consideration of cross-relational and cross-functional analysis of several characteristics of a process in consideration of various parameters of estimated values.

4. Complete Decomposition Algorithm

A multisensor data fusion method according to an embodiment of the present invention is implemented as follows. First, a process for the method is initialised. Then, a source signal is detrended and centered. Then, Karhunen-Loewe decomposition is performed according to a discrete case. (There are two approaches: one for analogue and of for digital cases, resulting in solid and discrete data.) Then, [symbol] and [symbol] are computed. Then, error estimation is computed using J(a⁰)(28). Then, within a predetermined period, an estimation is updated, and a minimization function for the error estimation is computed. Then, the process is repeated from the centering and detrending of the source signal.

The above-described operations provide a close-loop sequence for fusion signal processing and prediction.

5. Object-Like Semi-Level Information Fusion

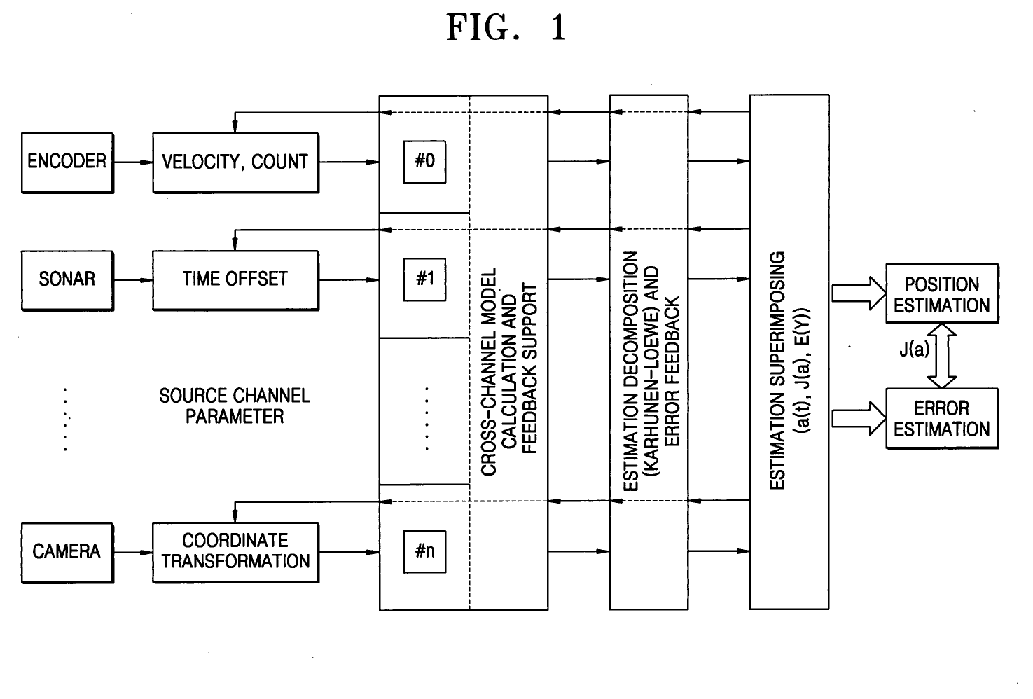

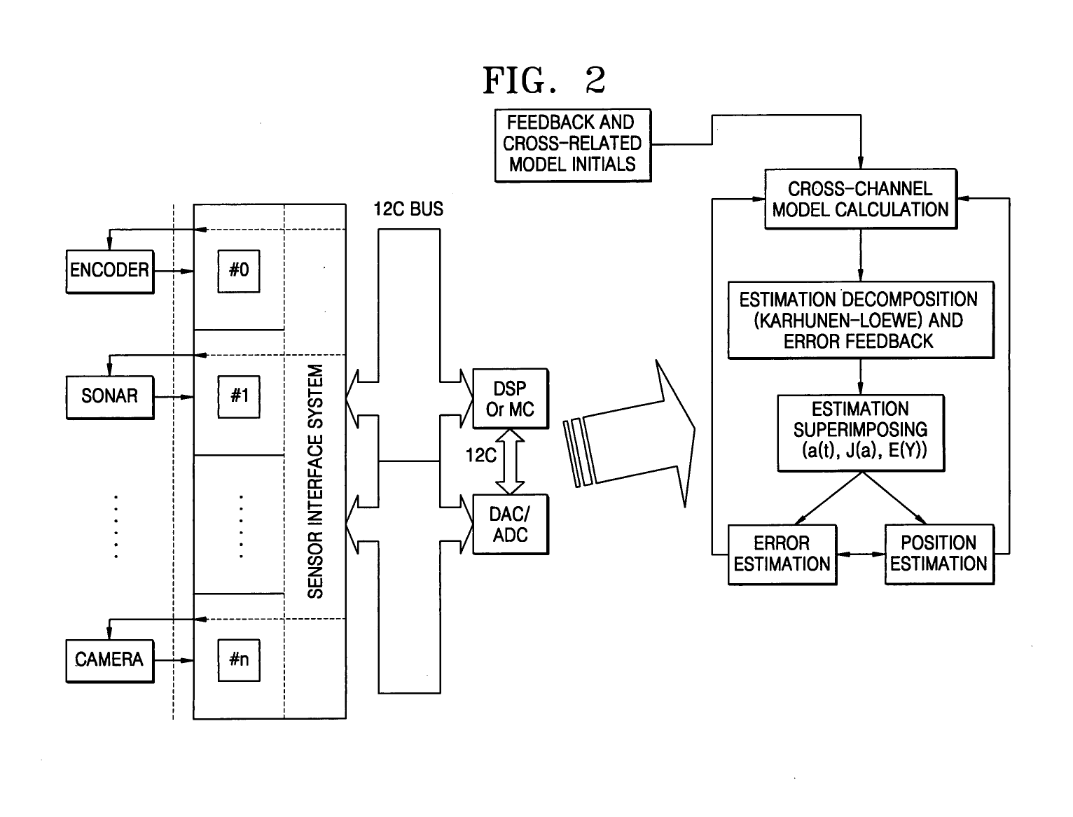

According to all of the above descriptions, it is possible to construct a fusion system (as shown in FIGS. 1 and 2) that is scalable, survivable, and modular, and performs error estimation and output correction for each fusion channel. Because of the scalable property, the fusion system can be easily extended or compressed under some environmental conditions. Because of the survivable property, if one of the sensor sources is lost or malfunctions, it is not a disaster for the whole system, it just decreases exponential-related error estimation. Because of the modular property, the fusion system easily understands what kind of sensor is responsible for what kind of sensing. The fusion system can perform the error estimation and output correction for each fusion channel. Thus, every sensor source has its own non-recursive error estimation and warning ability for the next level data fusion.

A method of fusing data signals includes: dynamically observed data with a plurality of models parameters that sense position estimation result of the robot; selectively combining (cross-relative) the results of the plural models parameters; detecting changes in expected reliabilities of the plural models parameters influenced by the observations; and producing synthesized assessments of a estimation and error distribution over a ground truth represented by an unknown state of the sensors data and desired inference.

In the step of dynamically observed data with the plurality of models parameters, dynamically observed data are real-time information from sensors. According to the sensor we can construct it equal dynamical model (a sensor transfer function represented as a decomposition model component). Using the sensor transfer function, we can determine which parameters are more important. To do this, it is necessary to calculate an input of every parameter. It could be done with calculation of each parameter weight coefficient. To calculate a weight coefficient we can use an auto-regression analysis procedure. Equations 14 through 19 channel (sensor) represents decomposition model.

In the step of selectively combining (cross-relative) the results of the plural models parameters, as mentioned before, we can determine which parameter has which input (weight). For proper calculation of a sensing fusion approach we need to determine relations between sensors parameter models. To do this we need to calculate cross-correlation between sensor channels and determine channels (sensors) decomposition model. It is a standard procedure to determine a model's degree of freedom and relations between different parts of the whole model. After analysis, it can be decided which channel (sensor model) is more effective to be used during position and error estimation.

Also these results are used to analyze error distribution and corresponding channel error compensation. Equations 9, 13, 24 and 28 represents error estimation, Equations 14 through 19 represent a decomposition model, Equations 21 through 24 and 27 represents a link between the error estimation and the decomposition model.

In the step of detecting changes in expected reliabilities of the plural models parameters, channel's (sensor's) models and corresponding parameters need to be tracked for proper model performance. To do this, it is necessary to track J(a) in real-time. As it is proposed herein, sometimes tracking is difficult to do because of huge data arrays and flows. But, a main difference of current approach is to use decomposition models instead of a linear combination of channel's (sensor's) models. That's why real-time computational capabilities can be achieved. So, tracking these changes in real-time in made possible using Equation 28.

In the step of producing synthesized assessments of the estimation and error distribution, final equations for algorithm, namely, Equations 28 through 33, can be produced after constructing a channel's (sensor's) model, decomposition models, and a cross-correlation analysis.

These equations are main results to obtain estimation and error distribution.

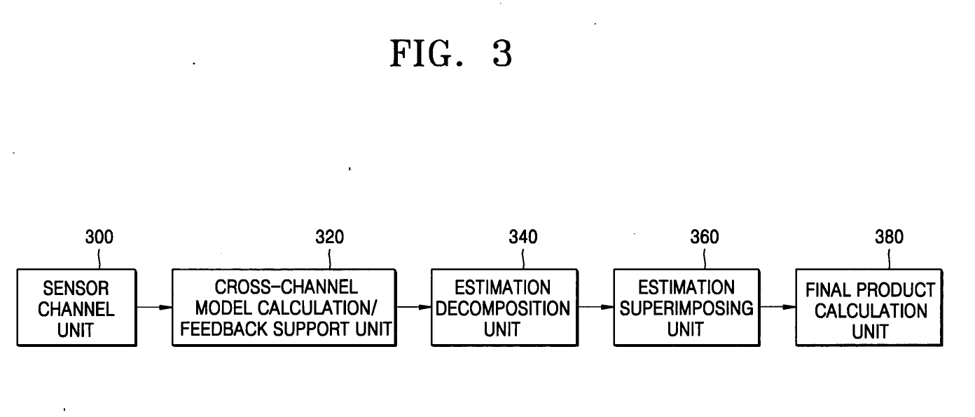

FIG. 3 is a block diagram of a constitution of the system of FIG. 1. The system includes a sensor channel unit 300, a cross-channel model calculation/feedback support unit 320, an estimation decomposition unit 340, an estimation superimposing unit 360, and a final product calculation unit 380.

The sensor channel unit 300 includes a sensor hardware layer and a software layer corresponding to the sensor hardware layer. The software layer feeds sensors with power supply and control signal sequences, extracts raw data from the sensors, and feeds the extracted raw data to a pre-processing layer. At this time, signal-related models are constructed using the following method:

(1) Signal analyzing is performed on a spectrum by processing signal data through fast Fourier transform (FFT). It is possible to track the state of a spectrum function and predict or analyze the state of a sensor channel. It is also possible to fit a polynomial to the spectrum function using an auto-regression method (with a Least Mean Square Error method). The main advantage of this method is that in-process signal monitoring and analyzing can be easily achieved with the help of signal-related model. Hence, diagnostics-like signal channel processing is possible.

(2) A model of a channel parameter block is introduced in a signal channel. This provides flexible feedback support for channel parameter tuning because some in-process or off-line tuning for proper functioning needs to be performed during an operational cycle of every device. Thus, if abstract models of a channel can be obtained, key parameters of the channel can be obtained. During some time later, tuning of the channel can be performed according to the environmental conditions.

The cross-channel model calculation/feedback support unit 320 calculates cross-products for further performing the fusion algorithm. To do this, cross-related products, such as cross- and auto-correlation of channels, are needed. Error feedback support for the channel parameter tuning is provided because error estimation for the whole signal processing picture representation needs to be obtained according to signal processing methods. Several points need to be specified. First, there are two kinds of methods that can be used to calculate a correlation function: a method of using ordinary raw signal transformation via integral convolution; and a method of using spectrum functions and power spectrum functions. Second, these methods provides not only a calculation of a simple correlation function but also a determination of a cross-noise weight in signal channels. Information about key features of the environment can be extracted at early stages, by analyzing a signal spectrum function. Hence, the cross-channel model calculation/feedback support unit 320 can obtain cross-related products, error minimization feedback support, and key frequencies of sensor channels.

The estimation decomposition unit 340 produces a linear combination of orthogonal weight functions. A set of weight functions for estimation signal representation is produced using signal key features and corresponding mathematical background. An error estimation equation must also be considered. Using the error estimation equation, rules for error compensation performed by the sensor channel unit 300 may be properly obtained. The estimation superimposing unit 360 performs an estimation calculation and uses a minimization equation for optimal signal processing.

The estimation superimposing unit 360 superimposes a set of weight functions for decomposed estimation over a set of decomposition weight coefficients and a corresponding set of estimations of distributed random values over measured signal values. Accordingly, a final product of fused signal estimation can be obtained. It is also necessary to estimate an error minimization function.

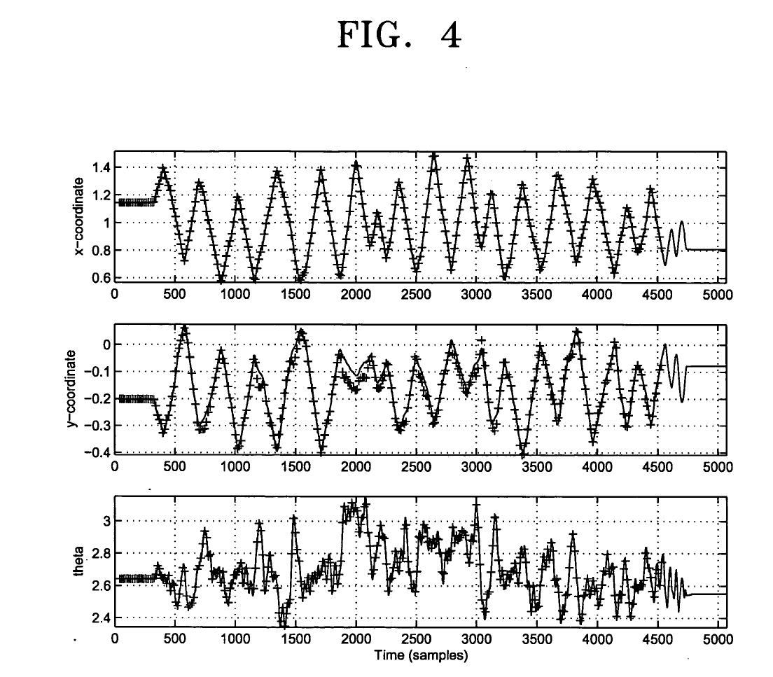

The final product calculation unit 380 extracts information about a position of a mobile device, analyzes error-related data, and extracts necessary information related to a final product calculation. The final product calculation unit 380 also extracts key features related to localization according to a position and a current state of the mobile device. Thereafter, the final product is correlated with an environmental state. Consequently, as shown in FIG. 4, unscaled and uncalibrated information about the position of the mobile device is obtained.

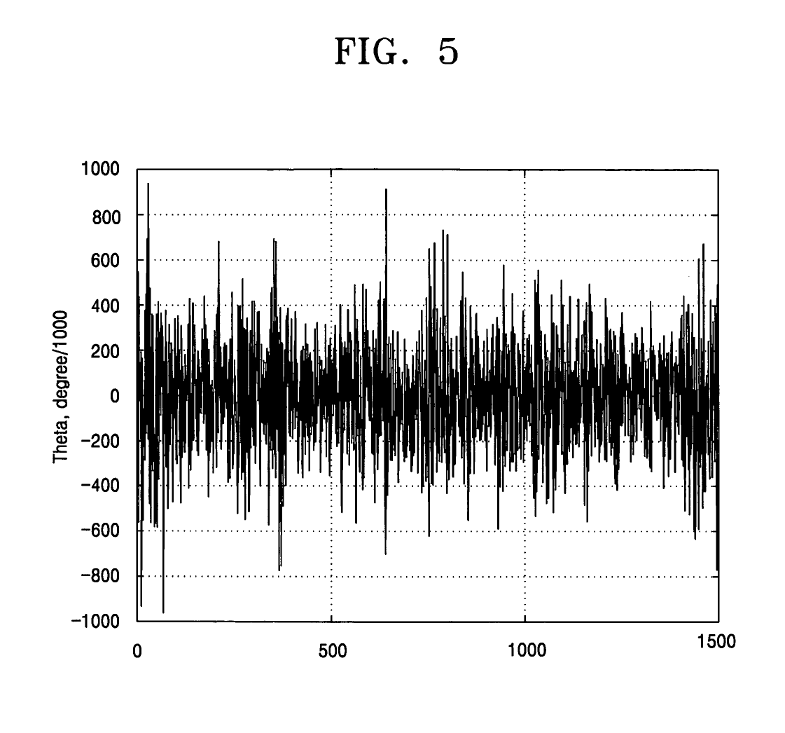

The following process can be used for sensor signal processing. First, as shown in FIG. 5, a raw signal is received (real time buffer with a time shift Tₛ≦40 ms) and processed through a weight function of the system. Second, the signal is Fast Fourier Transformed to obtain a spectrum function of the signal. Third, within the spectrum function, it is possible to analyze qualitative properties of the signal, including weight frequencies, a spectrum range, a form and a type of the signal, and what part of the system is responsible for a defined part of frequencies in the spectrum. Fourth, it is possible to obtain an auto-regression model and then analyze spectrum properties of the spectrum function by using a root distribution in the T-R domain. The type and kind of such a distribution can describe model decomposition layers. With the help of this analysis, it is possible to obtain a relationship between several parameters of the whole system (for example, a relationship between speed and orientation parameters in a kinematics model of a differential driven robot. Fifth, it is possible to make a compact, versatile mathematical & software set by performing real-time monitoring and diagnosing for each sensing channel.

A fusion system according to the present invention is scalable, so it can be easily expanded or compressed under any environmental conditions. The fusion system is also survivable, so if one of the sensor sources is lost or malfunctions, it is not a disaster for the whole system but it just decreases exponential-related error estimation. The fusion system is also modular, so it can easily determine what kind of sensor is responsible for what kind of sensing. Further, the fusion system can perform error estimation and output correction for each fusion channel. Hence, every sensor source has its own non-recursive error estimation and a warning ability for the next level data fusion.

It will be appreciated that the present invention has been described by way of exemplary embodiments to which it is not limited. Variations and modifications of the invention will occur to those skilled in the art, the scope of which is to be determined by the claims appended hereto.

What is claimed is:

1. A method of navigating an unmanned vehicle, comprising:
measuring a plurality of parameters using at least two sensors that sense a result of a position estimation of the unmanned vehicle;
selectively combining the measured parameters;
detecting changes of the parameters within expected ranges; and
estimating a position of the unmanned vehicle represented by sensor data and desired data deviation, using estimation and error distribution.

2. The method of claim 1, wherein the measuring of the parameters comprises:
receiving a source signal;
transforming the source signal into a frequency-domain signal using fast Fourier transformation and calculating a spectrum density function; and
fitting a polynomial to a spectrum- and signal-dependent representation and calculating a corresponding correlation function and corresponding coefficients.

3. An apparatus navigating an unmanned vehicle using sensor fusion, the apparatus comprising:
a sensor channel unit including sensors and control signal sequences, extracting raw data from the sensors, and transmitting the raw data to a pre-processing layer;
a cross-channel model calculation/feedback support unit calculating cross-products including cross- and auto-correlation channels to perform a fusion algorithm, supporting error feedback for channel parameters, and obtaining error estimation for signal processing representation;
an estimation decomposition unit generating a linear combination of orthogonal weight functions, generating a set of weight functions for estimation signal representation corresponding to signal key features, and obtaining rules for error compensation in consideration of an error estimation equation;
an estimation superimposing unit that superimpose the weight function generated by the estimation decomposition unit on a set of decomposition weight coefficients and a corresponding set of estimations of distributed random values on measured signal values; and
a final product calculation unit extracting necessary information related to a final product calculation, extracting key features related to localization according to a position and a current state of the unmanned vehicle, correlating a final product with an environment state, and obtaining unscaled and uncalibrated information about the position of the unmanned vehicle.

4. The apparatus of claim 3, wherein the sensor channel unit analyzes a signal in a spectrum domain by processing signal data using a fast Fourier transform.

5. The apparatus of claim 4, wherein the sensor channel unit tracks a state of a spectrum function, predicts and analyzes a state of a sensor channel, fits a polynomial to the spectrum function using an auto-regression method and a least mean-squared error method, obtains key parameters of the sensor channel using abstract models of the sensor channel, and tunes the sensor channel during some time according to the environmental conditions.

6. The apparatus of claim 3, wherein the cross-channel model calculation/feedback support unit uses raw signal transformation via integral convolution, spectrum functions, and power spectrum functions to calculate a correlation function, determines a cross-noise weight in signal channels using the spectrum functions and the power spectrum functions, analyzes a signal spectrum function, extracts information about the environment at early stages, and obtains cross-related products, error minimization feedback support, and key frequencies of sensor channels.

7. A computer-readable recording medium in which a computer program for executing the method of claim 1 is recorded.
